(19) United States
(12) Patent Application Publication
(10) Pub. No.: US 2024/0254009 A1
(43) Pub. Date: Aug. 1, 2024

(54) Removing Residual PFAS from Internal Surfaces of Firefighting Equipment

(71) Applicant: The ERM International Group Limited, London (GB)

(72) Inventor: Jeff McDonough, Highlands Ranch, CO (US)

(73) Assignee: The ERM International Group Limited, London (GB)

(21) Appl. No.: 18/160,469

(22) Filed: Jan. 27, 2023

(51) Int. Cl. C02F 1/02; C02F 1/72

(52) U.S. Cl. CPC C02F 1/02; C02F 1/72; C02F 2101/36

(57) ABSTRACT

Methods for removing PFAS from firefighting equipment in closed-loop systems by heating an effluent to a first temperature, circulating at a first flow rate the effluent heated to the first temperature through equipment containing residual PFAS, wherein the first temperature and the first flow rate enable removal of residual PFAS from an interior of the equipment, and heating the effluent to a second temperature for a period of time, wherein the second temperature and the period of time enable the removed PFAS to be substantially destroyed.

### TECHNICAL FIELD

The present disclosure relates to cleaning per and polyfluoroalkyl substances (PFAS) from contaminated equipment and environments typically associated with fire-fighting foam.

### BACKGROUND

PFAS have been used in firefighting foams for decades. While efforts to switch to fluorine-free foams and, though concentration restrictions on PFAS exist, PFAS currently are commonly used in firefighting foams. Long chain PFAS may continue to be added to short chain PFAS foams to improve their performance.

Long chain PFAS are known to self-assemble. This self-assemblage creates layers of PFAS that typically start on surfaces. The fluorosurfactants that were used in firefighting foam are surfactants—surface acting agents. They exist to mitigate surface tension between phases and as such they are drawn to that interfacial tension. PFAS at the gas-liquid interphase and the solid-liquid interface, may be aggregated and interlocked forming various morphologies of supramolecular structures. Long chain PFAS in liquid firefighting foam concentrate that is stored in tanks, trucks, charged in pipes, hangars, etc. over time, and with continued use, may begin to form self-assembled layers on the wetted surface of the piping, tanks, or other conveyance equipment. Self-assembled layers may be referred to as “residual PFAS” within the infrastructure. According to this disclosure, “residual PFAS” means PFAS foam and PFAS self-assembled layers (or any other mechanism by which PFAS remain on surfaces [i.e., hydrophobic and/or electrostatic interactions]), which remains in equipment after use with PFAS. The self-assembled layers may be water insoluble. Cool water flushes may suggest no PFAS when sampled because the residual PFAS do not dissolve into the cool water. Residual PFAS self-assembled layers may be left behind. Common industry practice calls for three water rinses, but this process may not remove significant residual PFAS self-assembled layers. Likely, residual PFAS self-assembled layers not completely removed from interior surfaces of equipment subsequently dissolve into whatever replacement foam is later added into the equipment.

Varying amounts of the residual PFAS may be removed using water and/or chemical solvents. According to this disclosure, “chemical solvent” means solvents other than tap water such as water with an additive, including for example: methanol (MeOH), FluoroFighter® (FF) (Arcadis), PFAScrub™ (TetraTech), and/or PerfluorAd® (TRS/Cornelsen). This is a chemical extraction technique because the chemical solvent is hypothesized to be effective at interrupting and dissolving the self-assembled PFAS layers/residual PFAS within a wetted conveyance infrastructure. Cleaning equipment with chemical solvents produces large volumes of PFAS-impregnated solvents, that may be classified as a hazardous substance with few management options. Further, fluorine may be left behind on the internal surfaces of the infrastructure. Conventionally, the temperature of chemical solvents has been varied 22, 40, 50, and 80 degrees Celsius to increase effective removal of PFAS. Thus, prior PFAS removal processes use increased temperature to enhance chemical extraction with chemical solvents.

For example, the residence time within a super critical water oxidation (SCWO) reactor may be 9-11 seconds, and may be adjustable with reduced flow. The resultant heat from the destruction coming out of the SCWO enhances the cleaning and may produce a zero-waste system.

There is a need for PFAS removal processes that effectively removes residual PFAS from internal surfaces of equipment without generating PFAS-impregnated solvents or other hazardous waste.

### SUMMARY OF THE INVENTION

Aspects of the invention include PFAS removal methods that include temperature only effluents and ingredients.

An aspect provides a method comprising: heating an effluent to a first temperature; circulating at a first flow rate the effluent heated to the first temperature through equipment containing residual PFAS, wherein the first temperature and the first flow rate enable removal of residual PFAS from an interior of the equipment; and heating the effluent to a second temperature for a period of time, wherein the second temperature and the period of time enable the removed PFAS to be substantially destroyed.

According to one aspect, there is provided a system comprising: a heater capable of heating an effluent to a first temperature; a pump capable of circulating at a first flow rate the effluent heated to the first temperature through equipment containing residual PFAS, wherein the first temperature and the first flow rate enable removal of residual PFAS from an interior of the equipment; and conduit connecting the heater, the pump, and the equipment containing residual PFAS in a closed-loop.

### BRIEF DESCRIPTION OF THE DRAWINGS

The figures illustrate a PFAS removal processes that effectively remove residual PFAS self-assembled layers from internal surfaces of equipment without generating PFAS-impregnated solvents or other hazardous waste.

FIG. 1A shows a schematic diagram of a system to remove residual PFAS self-assembled layers from equipment.

FIG. 1B shows a cross-sectional, side view of an interior surface of the equipment shown in FIG. 1A, wherein the surface is shown in three views with heavy, moderate, and no residual PFAS self-assembled layers, respectively.

FIG. 2 shows a block diagram illustrating effluent flowing through the system of FIG. 1, and further depicting the effluent flowing from the super critical water oxidation (SCWO) reactor to a gas-liquid separator and cooler.

FIG. 3 shows a flow chart of a method for removing PFAS from firefighting equipment with an effluent at a first temperature and destroying PFAS in the effluent at a second temperature.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

Aspects of the invention may include PFAS removal systems and methods that include temperature only effluents and ingredients, for example water without any other chemical solvent.

Warmer solvents (even warmer water) may clean out residual PFAS from equipment. Solvents at 20, 40, 60, and 80 degree Celsius may remove residual PFAS self-assembled layers from carbon steel, fiberglass/epoxy, or any other material used to convey or store firefighting foam that is compatible with warm temperatures.

Aspects provide for the use of elevated temperature water to remove residual PFAS from equipment. Alternative aspects provide for ozone or a mineral acid/base (all inorganic) to be injected in water to remove residual PFAS.

A heater may be used to heat effluent to temperatures between 50° C. and 99° C. prior to circulating the effluent through firefighting equipment previously in contact with PFAS. A super critical water oxidation (SCWO) reactor, such as offered by General Atomics, may be used to heat effluent.

A SCWO reactor may produce an effluent at a temperature sufficiently high to remove residual PFAS self-assembled layers. A SCWO unit, such as offered by General Atomics, may produce effluent at about 10 degrees to about 100 degrees Celsius. Some of the SCWO units may run at 1-10 gallons per minute (gpm), or more specifically 2-4 gpm. For example, if a 500-gallon foam cell on a fire truck is to be cleaned with approximately 50 gallons of hose/piping conveyance, a circulation loop may be set up to exchange a pore volume once every 3 hours. The foam cells and conveyances for fire trucks are typically insulated within the body of the truck, which may conserve heat. Fire trucks and other firefighting equipment vary widely and apply different aspiration techniques, so the ability of individual pieces of equipment to conserve heat may also vary widely. A SCWO may provide a constant heat source, such that the effluent flowing therefrom may have a constant temperature. The temperature of the effluent returning from the equipment being cleaned may be monitored. With a constant fluid flow through the system, a minimum temperature of the effluent in the equipment being cleaned may be established by setting the SCWO effluent temperature high enough so that the returning effluent temperature is above the minimum temperature desired for cleaning.

Aspects of a temperature only process to remove residual PFAS including self-assembled layers may provide chemical compatibility with all equipment materials, for example, carbon steel pipe and/or fiberglass/epoxy pipe, etc. Equipment made with Schedule 40 polyvinyl chloride (PVC) may be suitable because it is rated above 100 degrees Celsius without significant pressure load reduction.

An aspect of the invention may provide sufficient residence time for the temperature elevated solvent to remove residual PFAS self-assembled layers from equipment. Residence times may vary depending on temperature.

A temperature only process to remove residual PFAS self-assembled layers from equipment may further include returning the PFAS that are removed by the thermal energy of the water to the influent of a SCWO chamber to completely destroy the PFAS at significantly elevated temperature and pressure and low residence time.

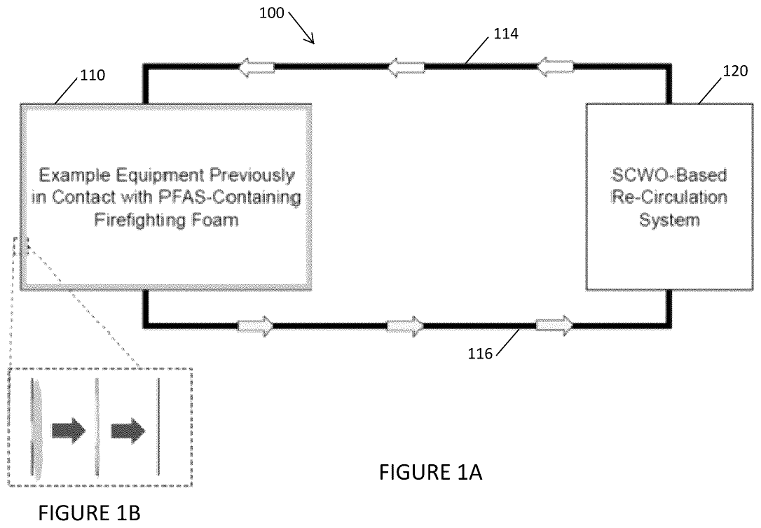

FIG. 1A shows a schematic diagram of a system to remove residual PFAS self-assembled layers from equipment. A closed-loop system 100 may be used to circulate effluent through firefighting equipment 110 and a SCWO reactor 120. A supply line 114 allows effluent to be pumped from the SCWO reactor 120 to the firefighting equipment 110. A return line 116 allows effluent laden with PFAS to be pumped from the firefighting equipment 110 to the SCWO reactor 120.

FIG. 1B shows an expanded cross-sectional view of an interior wall surface of the firefighting equipment 110, shown in FIG. 1A, in three different stages of PFAS removal, wherein the surface is shown in three views with heavy, moderate, and no residual PFAS self-assembled layers, respectively. Heated Super Critical Water Oxidation (SCWO) effluent may be used to “desorb” or “dissolve” residual PFAS from the interior surfaces of equipment being cleaned. By adjusting the temperature, flow rate, and residence time of the effluent circulating through the firefighting equipment 110, the removal rate of the PFAS from the interior surfaces of the firefighting equipment 110 may be modified. Higher temperature and faster flow rate tend to increase PFAS removal rate.

PFAS may be destroyed onsite within a closed loop system 100, wherein a portion of heat used to destroy PFAS is used to desorb PFAS in a sustainable process. For example, elevated temperature effluent may be circulated through the PFAS containing equipment to remove residual PFAS self-assembled layers from the firefighting equipment 110. However, the temperature of the effluent may not be sufficiently high to destroy the PFAS. The effluent containing PFAS is circulated from the firefighting equipment 110 back to the SCWO reactor 120 where its temperature is super-elevated. The temperature of the super-elevated effluent combined with a residence time in the SCWO reactor 120 may be sufficient to destroy the PFAS.

Super Critical Water Oxidation (SCWO) effluent at elevated temperature is presently theorized to “desorb” or “dissolve” residual PFAS from the interior surfaces of firefighting equipment 110 being cleaned. However, desorption and dissolution may not be the only mechanisms of removal. Other chemical interactions and processes may also cause removal. The precise mechanism is not material. Rather, aspects of the invention involve the use of elevated temperature effluent at flow rates and residence periods sufficient to remove residual PFAS.

In the system shown in FIG. 1A, the temperature of the effluent may decrease after it exits the SCWO reactor 120 and may continue to decrease until it again enters the SCWO reactor 120. The supply line 114, the return line 116, and the firefighting equipment 110 previously in contact with PFAS-containing firefighting foam may not be well insulated so that heat energy may be lost to the environment, which causes the temperature of the effluent to decrease as it circulates through the closed-loop system 100. In one example, the temperature of the effluent may be about 80 degrees Celsius upon exit of the SCWO unit, and by the time it circulates through the firefighting equipment 110 previously in contact with PFAS-containing firefighting foam and returns to the entrance of the SCWO reactor 120, the temperature of the effluent has decreased to 40 degrees Celsius. If the temperature of the effluent is maintained above about 40 degrees in the firefighting equipment 110 previously in contact with PFAS-containing firefighting foam, the residual PFAS self-assembled layers may be removed from the internal surfaces of the firefighting equipment 110 previously in contact with PFAS-containing firefighting foam. However, 40 degrees Celsius may not be sufficiently hot to destroy the PFAS in the circulating effluent. When the effluent returns to the SCWO reactor 120, laden with PFAS, the SCWO reactor 120 may heat the effluent to a temperature between about 100 degrees Celsius and about 650 degrees Celsius. The flow rate of the effluent may be adjusted to allow it to reside long enough at a sufficiently high temperature to destroy the PFAS. A residence time of 9-11 seconds at about 650 degrees Celsius may destroy the PFAS in the effluent. Effluent at other temperatures and other residence time may also destroy the PFAS in the effluent, for example, about 100-370 degrees Celsius for about 5-30 seconds.

A SCWO reactor 120 may pressurize water to about 220 Bar and heat the water to its critical point about 373 degrees Celsius at that pressure. Super critical water is water that is pressurized to about 220 Bar enabling its heating capabilities to far exceed that of 100 degrees Celsius boiling point at 1 bar (standard conditions). Water at elevated temperature and pressure may destroy PFAS in the water.

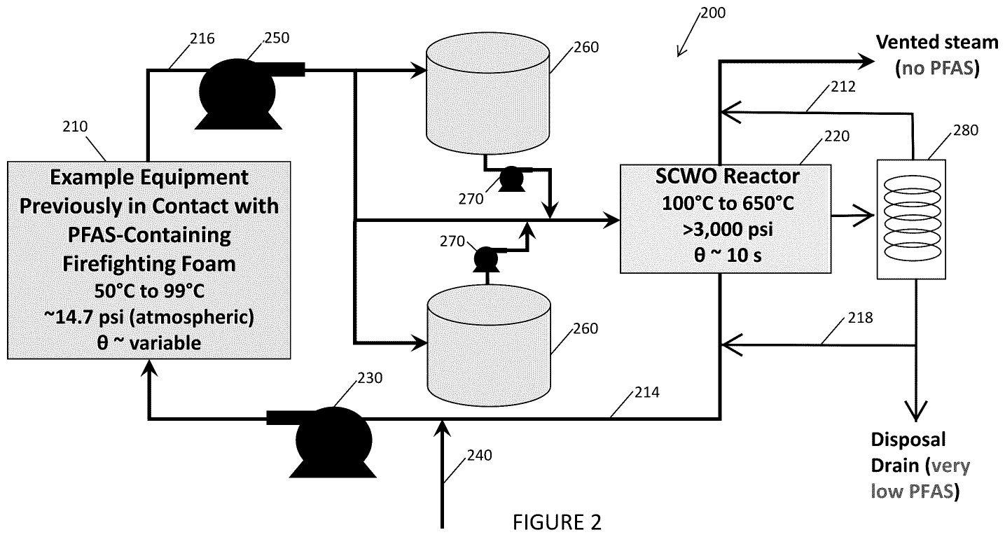

FIG. 2 shows a schematic diagram illustrating effluent flowing through a closed-loop system 200, similar to the closed-loop system 100 of FIG. 1. FIG. 2 illustrates the effluent flowing from the SCWO reactor 220 to a gas-liquid separator 280. Alternatively, the liquid-gas separator may be incorporated into the SCWO reactor as a single piece of equipment. Effluent returning to the SCWO reactor 220 may be laden with PFAS removed from the firefighting equipment 210 previously in contact with PFAS-containing firefighting foam. After the effluent is heated in the SCWO reactor 220, much of the PFAS may be destroyed. As illustrated in FIG. 2, the effluent may pass from the SCWO reactor 220 into a gas-liquid separator 280 where gaseous effluent and liquid effluent streams may be produced. The gaseous effluent may be vented via gas line 212 and the liquid effluent stream may be returned to the supply line 214 via a liquid line 218. The gaseous effluent may have almost no PFAS and may be safely vented to the atmosphere. The liquid effluent may also have very low levels of PFAS and may be circulated to a disposal drain or even safely discharged to the environment.

FIG. 2 illustrates a closed-loop system 200. An input of a firefighting equipment 210 is connected to an output of a SCWO reactor 220 with a booster pump 230 between. A makeup water line 240 may feed into the line between the SCWO reactor 220 and the booster pump 230 to supplement the water volume from the SCWO reactor 220. The booster pump 230 may increase flow rate or fluid pressure, and create agitation and/or purposefully direct flow (1× to 10× SCWO discharge). The output of the firefighting equipment 210 may be connected to a discharge pump 250, which is then connected directly to the SCWO reactor 220 and/or indirectly connected to the SCWO reactor 220 through one or more equalization tanks 260. Each equalization tank 260 may have an associated tank pump 270 to pump effluent from the equalization tank 260 to the SCWO reactor 220. Steam may be vented directly from the SCWO reactor 220 or from a gas-liquid separator 280. The fluid pipes connecting the components of the system 200 may be insulated to maintain effluent temperature as the fluid flows through the closed-loop system 200.

According to one aspect, effluent from the SCWO reactor 220 may be water at a temperature between 50° C. to 99° C. and pressure about 1 Bar (atmospheric). Effluent may be pumped through the firefighting equipment 210 at a temperature between 50° C. to 99° C. and pressure about 1 Bar (atmospheric). Alternatively, the SCWO reactor 220 may superheat water effluent to a temperature of 100° C. to 650° C. and pressure exceeding 206 Bar. Depending on the capacity of the firefighting equipment to accommodate elevated temperatures and pressures, effluent may be pumped through the firefighting equipment 210 at a temperature between 100° C. to 650° C. and pressure up to 206 Bar. The residence time of the effluent in the firefighting equipment 210 may vary depending on initial temperature, pressure, and heat loss.

Effluent discharged from the firefighting equipment 210 may be impregnated with PFAS. The effluent discharge may be pumped by the discharge pump 250 to the equalization tanks 260 for later processing or pumped directly back to the SCWO reactor 220. The SCWO reactor 220 may superheat the PFAS laden discharge effluent from the firefighting equipment 210 to a temperature of 100° C. to 650° C. and pressure exceeding 206 Bar and allow for a residence time in the SCWO reactor 220 between about 5-30 seconds, and in particular between about 9-11 seconds. Under these conditions, the PFAS may be effectively destroyed and the effluent may be returned to the firefighting equipment 210 to remove more PFAS therefrom.

One aspect of the invention is to provide a method wherein PFAS is removed from equipment previously in contact with PFAS-containing firefighting foam and destroyed on the equipment site. The effluent is heated by a SCWO unit. The heated effluent is circulated through equipment previously in contact with PFAS-containing firefighting foam, whereby residual PFAS self-assembled layers is removed from the interior surfaces of the equipment and carried away by the effluent. The effluent is returned to the SCWO unit and heated to a temperature sufficiently high for a period of time sufficiently long to destroy the PFAS. The effluent may then pass to a gas-liquid separator and cooler, whereby it is separated into a gaseous effluent and a liquid effluent. The SCWO unit and the gas-liquid separator and cooler may be located on the same site as the equipment previously in contact with PFAS-containing firefighting foam.

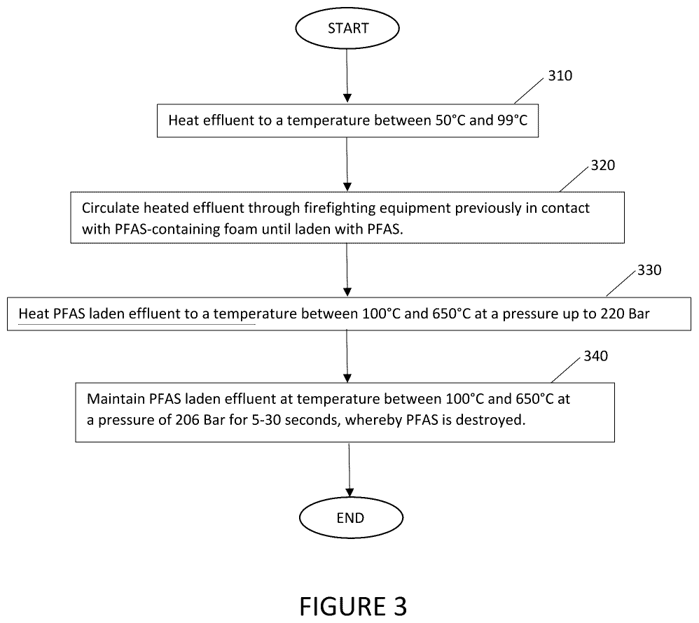

FIG. 3 provides a flow chart for a method of removing PFAS from firefighting equipment and destroying it. An effluent (e.g., water) is heated 310 to a temperature between about 50° C. and about 99° C. The heated effluent is circulated 320 through firefighting equipment previously in contact with PFAS-containing foam until laden with PFAS. The PFAS laden effluent is heated 330 to a temperature between 100° C. and 650° C. and pressurized >206 Bar. The PFAS laden effluent is maintained 340 at a temperature between 100° C. and 650° C. and a pressure exceeding 206 Bar for 5-15 second, whereby PFAS is destroyed.

Although examples have been described above, other variations and examples may be made from this disclosure without departing from the spirit and scope of these disclosed examples.

What is claimed is:

1. A method comprising:
heating an effluent to a first temperature;
circulating at a first flow rate the effluent heated to the first temperature through equipment containing residual PFAS, wherein the first temperature and the first flow rate enable removal of residual PFAS from an interior of the equipment; and
heating the effluent to a second temperature for a period of time, wherein the second temperature and the period of time enable the removed PFAS to be substantially destroyed.

2. The method as claimed in claim 1, wherein the first temperature is between 50° C. and 99° C.

3. The method as claimed in claim 1, wherein the first flow rate is between 1 gpm and 10 gpm.

4. The method as claimed in claim 1, wherein the second temperature is between 100° C. and 650° C.

5. The method as claimed in claim 1, wherein the effluent consists of water.

6. The method as claimed in claim 1, wherein the effluent substantially comprises water.

7. The method as claimed in claim 1, wherein the effluent does not contain a chemical solvent.

8. The method as claimed in claim 1, comprising separating the effluent heated to the second temperature into a gas stream and a liquid stream.

9. The method as claimed in claim 1, wherein the period of time is between 5 seconds and 30 seconds.

10. The method as claimed in claim 1, wherein the period of time is between 9 seconds and 11 seconds.

11. A system comprising:
a heater capable of heating an effluent to a first temperature;
a pump capable of circulating at a first flow rate the effluent heated to the first temperature through equipment containing residual PFAS, wherein the first temperature and the first flow rate enable removal of residual PFAS from an interior of the equipment; and
conduit connecting the heater, the pump, and the equipment containing residual PFAS in a closed-loop.

12. The system as claimed in claim 11, wherein the first temperature is between 50° C. and 99° C.

13. The system as claimed in claim 11, wherein the first flow rate is between 1 gpm and 10 gpm.

14. The system as claimed in claim 11, wherein the second temperature is between 100° C. and 650° C.

15. The system as claimed in claim 11, wherein the effluent consists of water.

16. The system as claimed in claim 11, wherein the effluent substantially comprises water.

17. The system as claimed in claim 11, wherein the effluent does not contain a chemical solvent.

18. The system as claimed in claim 11, comprising an equalization tank and the conduit connects the equalization tank in a closed-loop.

19. The system as claimed in claim 11, wherein the heater comprise a super critical water oxidation reactor.

20. The system as claimed in claim 11, comprising a gas-liquid separator in fluid communication with the conduit.
